(19) United States
(12) Patent Application Publication
(10) Pub. No.: US 2004/0203173 A1
(43) Pub. Date: Oct. 14, 2004

(54) Apparatus and methods for droplet dispensing

(76) Inventors: Bill J. Peck, Mountain View, CA (US); Eric M. Leproust, Campbell, CA (US); Lawrence J. DaQuino, Los Gatos, CA (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/408,887

(22) Filed: Apr. 8, 2003

(51) Int. Cl. B01L 3/00

(52) U.S. Cl. 436/180; 427/2.1; 422/100

(57) ABSTRACT

Droplet dispensing apparatus and methods are disclosed for reducing or eliminating deleterious effects caused by pressure transients on the droplet dispensing action of a droplet dispensing device. The droplet dispensing device usually comprises a plurality of nozzles. In the method fluid reagents are passed through a porous medium and into the droplet dispensing device. The porous medium is usually adjacent an inlet into the droplet dispensing device. In one embodiment the porous medium is coated with a desiccant material. In another embodiment the porous medium is in combination with a second porous medium, which is coated with a scavenger material.

### BACKGROUND OF THE INVENTION

This invention relates to droplet dispensing devices used in the manufacture of substrates or supports having bound to the surfaces thereof a plurality of chemical compounds, such as biopolymers. In one aspect the invention relates to the manufacture of arrays formed and arranged by depositing compounds or synthesizing large numbers of compounds on solid substrates in a predetermined arrangement. In another aspect this invention relates to the field of bioscience in which arrays of oligonucleotide probes are fabricated or deposited on a surface and are used to identify or analyze DNA sequences in cell matter.

In the field of diagnostics and therapeutics, it is often useful to attach species to a surface. One important application is in solid phase chemical synthesis wherein initial derivatization of a substrate surface enables synthesis of polymers such as oligonucleotides and peptides on the substrate itself. Substrate bound oligomer arrays, particularly oligonucleotide arrays, may be used in screening studies for determination of binding affinity. Modification of surfaces for use in chemical synthesis has been described. See, for example, U.S. Pat. No. 5,266,222 (Willis) and U.S. Pat. No. 5,137,765 (Farnsworth).

The arrays may be microarrays created on the surface of a substrate by in situ synthesis of biopolymers such as polynucleotides, polypeptides, polysaccharides, etc., and combinations thereof, or by deposition of molecules such as oligonucleotides, cDNA and so forth. In general, arrays are synthesized on a surface of a substrate or substrate by one of any number of synthetic techniques that are known in the art. In one approach, for example, the substrate may be one on which a single array of chemical compounds is synthesized. Alternatively, multiple arrays of chemical compounds may be synthesized on the substrate, which is then diced, i.e., cut, into individual assay devices, which are substrates that each comprise a single array, or in some instances multiple arrays, on a surface of the substrate.

There are several important design aspects required to fabricate an array of biopolymers such as cDNA's or DNA oligomers. First, the array sensitivity is dependent on having reproducible spots on the substrate. The location of each type of spot must be known and the spotted area should be uniformly coated with the DNA. Second, since DNA is expensive to produce, a minimum amount of the DNA solution should be loaded into any of the transfer mechanisms. Third, any cross contamination of different DNA's must be lower than the sensitivity of the final array as used in a particular assay, to prevent false positive signals. Therefore, the transfer device must be easily cleaned after each type of DNA is deposited or the device must be inexpensive enough to be a disposable. Finally, since the quantity of the assay sample is often limited, it is advantageous to make the spots small and closely spaced.

Similar technologies can be used for in situ synthesis of biopolymer arrays, such as DNA oligomer arrays, on a solid substrate. In this case, each oligomer is formed nucleotide by nucleotide directly in the desired location on the substrate surface. This process demands repeatable drop size and accurate placement on the substrate. It is advantageous to have an easily cleaned deposition system since some of the reagents have a limited lifetime and must be purged from the system frequently. Since reagents, such as those used in conventional phosphoramidite DNA chemistry may be water sensitive, there is an additional limitation that these chemical reagents do not come in contact with water or water vapor. Therefore, the system must isolate the reagents from any air that may contain water vapor for hours to days during array fabrication. Additionally, the materials selected to construct system must be compatible with the chemical reagents thereby eliminating a lot of organic materials such as rubber.

In situ syntheses of the type described above generally utilize a reaction chamber having a controlled environment in the reaction chamber. For example, many syntheses require an anhydrous environment to avoid the destructive effects of exposing chemical reagents to humidity present in the ambient atmosphere. Typically, an anhydrous chamber is created by placing the device for dispensing reagents in a reaction chamber through which dry gas is purged. The controlled environment is maintained within the reaction chamber especially during the insertion and removal of devices into and out of the reaction chamber.

In one approach to the synthesis of microarrays, an apparatus is employed that comprises a reaction chamber and a device for dispensing reagents to the surface of a substrate at discrete sites. A positioning system, which may be a robotic manipulator, moves the substrate to the chamber, in which at least a portion of the device for dispensing reagents is housed. Alternatively, the device for dispensing reagents may be moved in and out of the chamber. A controller controls the application of the reagents to the substrate according to predetermined procedures. The positioning system may comprise one or more stages for moving the substrate to various positions for the dispensing of reagents thereon. The stages may be, for example, an x,y- motor-driven stage, a theta stage, a rotational motor-driven stage, and the like.

As indicated above, one of the steps in the synthesis process usually involves depositing small volumes of liquid containing reagents for the synthesis, for example, monomeric subunits or whole polynucleotides, onto to surface of a support or substrate. In one approach, pulse-jet techniques are employed in depositing small volumes of liquid for synthesis of chemical compounds on the surface of substrates. For example, arrays may be fabricated by depositing droplets from a pulse-jet in accordance with known techniques. The pulse-jet includes piezo or thermal jets. Given the above requirements of biopolymer array fabrication, deposition using pulse-jet techniques is particularly favorable. In particular, pulse-jet deposition has advantages that include producing very small spot sizes. This allows high-density arrays to be fabricated. Furthermore, the spot size is uniform and reproducible. Since it is a non-contact technique, pulse jet deposition does not result in scratching or damaging the surface of the support on which the arrays are synthesized. Pulse-jet techniques have very high deposition rate, which facilitates rapid manufacture of arrays.

A pulse jet deposition system used for fabricating a biopolymer array should reliably deliver drops of reagent to precise locations on the substrate surface. A failure in any one of the drops dispensed during multiple drop dispensing results in an array product that must be discarded. One problem that occurs in the dispensing of multiple droplets from a droplet dispensing device comprising multiple nozzles is that pressure transients cause a de-priming of a fluid meniscus on the tip of the nozzle. As a result, a drop is not dispensed from the nozzle and an error in the deposition process occurs. The pressure transients often are due to line noise or vibration of the droplet dispensing device itself, both of which can result in vibration of the contents of the reservoir. This vibration causes the fluid reagent in the reservoir to become agitated. A pressure pulse travels through the droplet dispensing device causing the fluid meniscus to be sucked back into the nozzle chamber or causing the fluid meniscus to burst. In the latter circumstance, the fluid reagent released by the bursting coats the face of the nozzle. In both circumstances, a failure in the deposition process is realized.

There is a need, therefore, for an apparatus and process that would permit reliable and accurate automated dispensing from the nozzles of a droplet dispensing device used in deposition techniques for the production of arrays of biopolymers. The apparatus should provide for reduction or elimination of drop dispensing errors due to pressure transients so as to minimize deposition errors that might occur in the preparation of the arrays of biopolymers.

### SUMMARY OF THE INVENTION

One embodiment of present invention is a method for reducing or eliminating deleterious effects caused by pressure transients on the droplet dispensing action of a droplet dispensing device. The droplet dispensing device usually comprises a plurality of nozzles. In the method fluid reagents are passed through a porous medium and into the droplet dispensing device. The porous medium is usually adjacent an inlet into the droplet dispensing device. In one embodiment the porous medium is coated with a desiccant material. In another embodiment the porous medium is in combination with a second porous medium, which is coated with a scavenger material.

Another embodiment of the present invention is an apparatus for introducing a fluid reagent into an inlet of a droplet dispensing device, which usually comprises a plurality of nozzles. The apparatus comprises a housing, one or more fluid reagent channels in the housing having an end portion adapted for engagement with a fluid reagent inlet of the droplet dispensing device, and a porous medium in each of the channels adjacent the end portion. Optionally, the apparatus comprises one or more ports for introducing fluid reagents into respective channels. Optionally, the apparatus comprises a manifold for receiving fluids such as gases and directing fluids to the channels. In one embodiment the porous medium is coated with a desiccant material. In one embodiment the porous medium is in combination with a second porous medium, which is coated with a scavenger material.

Another embodiment of the present invention is an apparatus for synthesizing a plurality of biopolymer features on the surface of a substrate. The apparatus comprises a reaction chamber, a droplet dispensing device for dispensing reagents for synthesizing biopolymers on a surface of the substrate, an apparatus as described above in fluid communication with the droplet dispensing device, and a mechanism for moving the droplet dispensing device and the substrate relative to one another.

Another embodiment of the present invention is a method for synthesizing an array of biopolymers on a surface of a substrate. The method comprises, in multiple rounds of subunit additions, adding one or more polymer subunits at each of multiple feature locations on the surface to form one or more arrays on the surface. In each round of subunit additions, the substrate and a dispensing system for dispensing the polymer subunits for the synthesis of the biopolymers are brought into a dispensing position relative to the activated discrete sites on the surface. The dispensing system comprises a droplet dispensing device and an apparatus as described above. The polymer subunits are dispensed to the discrete sites. The substrate and/or the dispensing system are removed from the relative dispensing position, and the above steps are repeated.

Another embodiment of the present invention is a method for creating a negative backpressure at the nozzles of a droplet dispensing device comprising a plurality of fluid reagent inlets. The method comprises having in fluid communication with each fluid reagent inlet a volume of a porous medium. The flow of fluid reagents through the porous medium is controlled so that the fluid reagent occupies less than all of the volume of the porous medium to provide a negative backpressure for the droplet dispensing device.

### BRIEF DESCRIPTION OF THE DRAWINGS

FIG. 1 is a cross-sectional perspective view of one embodiment of an apparatus in accordance with the present invention.

FIG. 2 is a cross-sectional perspective view of another embodiment of an apparatus in accordance with the present invention.

FIG. 3 is a cross-sectional perspective view of another embodiment of an apparatus in accordance with the present invention.

FIG. 4 is a cross-sectional perspective view of another embodiment of an apparatus in accordance with the present invention.

FIG. 5 is a schematic depiction of an apparatus for synthesizing a plurality of chemical compounds on the surface of a support or substrate, which includes the apparatus of FIG. 1.

FIG. 6 is a perspective view of a substrate bearing multiple arrays.

FIG. 7 is an enlarged view of a portion of FIG. 6 showing some of the identifiable individual regions (or “features”) of a single array of FIG. 6.

FIG. 8 is an enlarged cross-section of a portion of FIG. 7.

### DETAILED DESCRIPTION OF EMBODIMENTS OF THE INVENTION

The present invention provides an automated apparatus for dispensing droplets of fluid reagents to form a plurality of biopolymers on the surface of a substrate. In the present invention the fluid reagent to be dispensed is passed through a porous medium. In this way deleterious effects of pressure transients are avoided as the fluid reagent travels through the porous medium. The apparatus may be placed in the reaction chamber (sometimes referred to as the deposition chamber) so that dry inert gas atmosphere therein may be maintained. In this way, the reaction chamber provides for an enclosed environment in which droplet dispensing devices are used. An example of a reaction chamber, for purposes of illustration and not limitation, is disclosed in U.S. patent application Ser. No. 10/035,787 filed Dec. 24, 2001, entitled “Small Volume Chambers.”

The porous medium employed is usually non-flexible. By the term “non-flexible” is meant that the porous medium is substantially rigid. In the context of the present invention, the non-flexible porous medium does not function by pore compression to any significant degree to absorb energy from a pressure transient as in the case of porous flexible foam, for example. In the present invention energy from a pressure transient is dissipated as the fluid reagent travels through the porous medium thereby reducing it to a non-damaging level.

The porous medium may be integral or non-integral. By the term “integral” is meant that the porous medium is a unitary element. Examples of integral porous elements, by way of illustration and not limitation, include formed sintered metal components (stainless steel, hastalloy, platinum, gold, silver, etc.), porous ceramic, porous rigid foam, and the like. By the term “non-integral” is meant that the porous medium is not a unitary element but, rather, is comprised of a plurality of rigid elements in close proximity thereby creating pores therebetween. Examples of non-integral porous elements, by way of illustration and not limitation, include rigid particulate material such as beads, e.g., glass beads, expanded metal such as, for example, metal wool, e. g., steel wool, metal mesh, and the like. It should be noted that the designation “integral” or “non-integral” as applied to metal wool and metal mesh may dependent on the method of manufacture.

The material from which the porous medium may be fabricated should be substantially inert to the fluid reagents employed in the fabrication of biopolymer arrays. By the term “substantially inert” is meant that the fluid reagent is not degradable by or reactive with such fluid reagents at least to the extent that the biopolymer fabrication would be compromised as to its intended use in conducting biological assays. Examples of suitable materials for fabrication of the porous medium, by way of illustration and not limitation, include glass, metal (stainless steel, hastalloy, Platinum, gold, silver, nickel, titanium), polyetheretherketone (PEEK), etc.

Suitable pore size of the porous medium is dependent on the viscosity of the fluid reagent, and the amount of damping required and the like. As the viscosity of the fluid reagent increases, the pore size of the porous medium may be increased. In general, the viscosity of the fluid reagent and the pore size of the porous medium should be such that pressure transients are dissipated as the fluid reagent travels through the porous medium. As an example, by way of illustration and not limitation, for a fluid reagent viscosity in the range of about 1 to about 10 cps, the size of the pores of the porous medium are usually about 0.1 to about 0.5 mm. Based on the above discussion, those skilled in the art will be able to determine appropriate pore size for a particular fluid reagent viscosity.

The porous medium is positioned between a source of fluid reagent and a fluid inlet of a droplet dispensing device so that the fluid reagent travels through the porous medium before encountering the fluid inlet. The porous medium may be in the form of a cylinder, column, plug, and the like. It should be noted in this regard that the container for the porous medium may be flexible or non-flexible. In general, the form of the porous medium may be of any geometry such that the distance the pressure wave travels is optimized for a given volume. Typically, a long column may be preferred over a short thin disc. Usually, the porous medium is positioned in a fluid communication line or channel that connects the source of the fluid reagent with the fluid inlet. For optimum results the porous medium should be positioned close to the fluid inlet. Ideally, the porous medium is immediately adjacent the fluid inlet. By the phrase “immediately adjacent” is meant that there is no free area occupied by gas between the porous medium and the fluid inlet of the droplet dispensing device.

The amount of the porous medium that is used in the present invention is dependent on the nature of the fluid reagent, the amount of fluid reagent, the available room due to geometry constraints of the droplet dispensing device and the like. In general, the amount of the porous medium is sufficient to achieve the desired dissipation of pressure transients that occur in the droplet dispensing process. Usually, the amount of the porous medium is about 0.5 to 5 cm³.

For a porous medium that is in the form of beads or particles, the size of the beads or particles is about 0.1 mm to about 2 mm, usually, about 0.5 mm to about 1 mm. For a porous medium that is in the form of a mesh, the spacing between the fibers is about 0.1 to about 1 mm. The spacing between the fibers is related to the size of the fibers, where the size of the fibers generally would set the spacing between the fibers in the mesh. For a porous medium that is in the form of a sintered metal insert, the size of the metal sinters is about 0.1 to about 2 mm, usually, about 0.2 to about 1 mm, where the size of the metal sinters generally would set the spacing between the fibers in the sintered metal insert. As is evident the size of the porous medium determines the spacing between the individual members of the porous medium and the size and nature of the path through which the fluid reagent passes.

As mentioned above, the porous medium is positioned between a source of fluid reagents and a fluid inlet of a droplet dispensing device. Depending on the form of the porous medium, it may be placed directly in a fluid communication line or channel between a source of fluid reagents and a fluid inlet into a droplet dispensing device. Such a placement may be employed with, for example, sintered metal inserts, and so forth. On the other hand, the porous medium may be in a separate housing such as a cartridge, bottle, and the like, which is placed in the fluid communication line or channel. Such a placement may be employed with, for example, glass or metal beads, and the like.

In one embodiment the present apparatus comprises a fluid reagent manifold, a droplet dispensing device and a plurality of channels in a housing between the manifold and the droplet dispensing device. The channels provide fluid communication between compartments in the manifold that contain fluid reagents and fluid inlets of the droplet dispensing device. The porous medium is disposed within the channels generally adjacent the fluid inlets. The dimensions of the channels should provide enough vertical height to permit capillary rise of fluid reagent therein and further to permit the necessary amount of vacuum that is supported by the pulse-jet head. The net vacuum on the nozzle is sufficient to prevent fluid reagent from rising above the porous medium. Usually, the net vacuum is about 1 to about 2 inches of water, more usually, about 1.5 inches of water. The dimensions of the channels should be about 10 to about 20 mm diameter by about 20 to about 100 mm high, usually, about 30 to about 60 mm high.

The porous medium usually occupies about 20 to about 90% of the channel, more usually, about 30 to about 50% of the channel. As explained more fully below, in one embodiment of the invention the amount of fluid reagent in the channel may be such that the fluid reagent does not cover the upper surface of the porous medium. During operation, the channels are filled to the desired level with fluid reagents for dispensing. The inlet for the fluid reagents into the channels is usually positioned above the area of the channel occupied by the porous medium. In some embodiments the inlet for the fluid reagents is positioned immediately above the upper level of the porous medium in the channel. By “immediately above” is meant that the inlet is positioned within about 1 cm or less, preferably within about 5 mm or less, of the upper level of the porous medium. This latter embodiment is generally employed where the level of fluid reagent in the channel is maintained below the upper level of the porous medium. The level of fluid reagent in a channel is generally detected by suitable sensors, which indicate high and low level of fluid reagent. The sensors are connected by suitable circuitry to a computer that then sends a signal to a valve to open or close to control the level of fluid reagent in the channel. Any suitable fluid level sensor may be employed as are known in the art. Such sensors include, for example, a self-heating thermistor, and the like. The sensors are placed at appropriate location within the channels depending on the levels of fluid reagents desired therein.

The housing for the channels may be constructed from a suitable material that provides structural strength to the housing. The walls of the channels should be constructed of material that is inert to the fluid reagents. This may be accomplished using inert materials for the housing body or by coating the inside walls of the channels with a material that is inert to the fluid reagents that are contained therein.

The compartments of the manifold are connected by suitable valves to sources for fluid reagents and a vent. The valves are computer controlled and are opened to the source of fluid reagent to provide the appropriate fluid reagent in the channels of the aforementioned device. Examples of such valves include pneumatic directional valves, solenoid operated poppet or diaphragm valves, and the like. The fluid reagent may be contained in a suitable reservoir that is in fluid communication with the channels.

As mentioned above, the droplet dispensing device usually comprises a plurality of nozzles, which are supplied by the fluid inlets of the droplet dispensing device. In one embodiment the nozzles are aligned in at least one row. The nozzles may be aligned in at least two rows, at least three rows, at least four rows, and so forth. Usually, the maximum number of rows is about 14. Preferably, the number of rows of nozzles is about 4 to about 8. In one embodiment the droplet dispensing device is a pulse jet type droplet dispensing device.

The droplet dispensing device is usually mounted inside a reaction chamber. The substrate may be moved into and within the reaction chamber to a position such that the dispensing surface of the dispensing device that has the nozzles is disposed over the surface of the substrate on which droplets are to be deposited. Usually, the dispensing surface is oriented in a downward direction.

The housing of the reaction chamber is generally constructed to permit access of the substrate into the reaction chamber. In one approach, the reaction chamber has an opening that is sealable to fluid transfer after the substrate is moved therein. Such seals may comprise a flexible material that is sufficiently flexible or compressible to form a fluid tight seal that can be maintained under increased pressures encountered in the use of the device. The flexible member may be, for example, rubber, flexible plastic, flexible resins, and the like and combinations thereof. In any event the flexible material should be substantially inert with respect to the fluids introduced into the device and must not interfere with the reactions that occur within the device. The flexible member is usually a gasket and may be in any shape such as, for example, circular, oval, rectangular, and the like. Preferably, the flexible member is in the form of an O-ring.

An apparatus of the invention usually includes a means for moving the apparatus into engagement with the dispensing surface of a droplet dispensing device as well as incrementally moving the present apparatus to various positions of engagement with such surface. Such means for moving the apparatus include, for example, a motion stage, pneumatic cylinder, a press, motor driven screw, clamp, linear electrical actuator such as, e.g., a solenoid or linear motor with or without positional feedback and the like. In an alternate approach, the substrate may be transported to and from the reaction chamber by a transfer element such as a robotic arm, and so forth. In one embodiment a transfer robot is mounted on a main platform of an apparatus for carrying out the syntheses of biopolymers on the surfaces of substrates. The transfer robot may comprise a base and an arm that is movably mounted on the base. In use, the transfer robot is activated and the arm of the robot is moved so that the substrate is delivered to a predetermined location in the reaction chamber. It is also within the purview of the present invention that the transfer robot be used in conjunction with a motion stage and the like.

In one embodiment of the invention, the porous medium is coated with a material that provides an additional processing advantage in the fabrication of biopolymers on the surfaces of substrates. Such processing advantages include, for example, removal of moisture from the fluid reagents, and so forth. The choice of material for coating the porous medium is dependent primarily on the processing advantage desired and the nature of the fluid reagent. The materials should be compatible with the fluid reagent and should not be reactive with or dissolve the fluid reagent to any significant degree. For the most part, such materials will be known or suggested to those skilled in the art.

Removal of moisture from the fluid reagent may be realized by coating the porous medium with a desiccant material. The choice of desiccant material is dependent on the nature of the fluid reagents used for the fabrication of biopolymer arrays on the surface of substrates, the nature of the porous medium, and so forth. One common fluid reagent employed in such fabrication employs propylene carbonate as the solvent. Other solvents may be, for example, those set forth in U.S. Pat. No. 6,028,189 (Blanchard), the relevant disclosure of which is incorporated herein by reference, and the like. Suitable desiccant materials may be, for example, 4-ethyl benzenesulfonyl chloride derivatized support, propionyl chloride derivatized support, propionyl derivatized support, 3-(2-succinic anhydride)propyl derivatized support, and so forth. The material coating the porous medium should be attached in a substantially irreversible manner so that that material does not become detached during the passage of the fluid reagent through the porous medium. Preferably, the coating material is covalently attached to the porous medium. The coating of the porous medium with the desiccant may be carried out by known procedures such as, for example, esterification, electrophilic reactions, and the like. The amount of the desiccant material coating the porous medium is dependent on the nature of the fluid reagent such as the expected moisture level, the nature of the support surface including porosity of the surface, and the like. In general, the amount of material coating the porous medium is sufficient to achieve the desired level of moisture removal from the fluid reagent and is usually determined empirically. Usually, it is desired to reduce the moisture level in the fluid reagent to below about 100 ppm, usually, below about 50 ppm.

Depending on the nature of the material employed to coat the porous medium, it may be necessary to remove any side reaction products that result from the action of the material employed on the fluid reagent. To this end a second porous medium that is coated with a scavenger material may be employed. In some instances, a single porous medium may be employed where the porous medium comprises both a desiccant and a scavenger material. For example, depending on the nature of a desiccant employed, there may be side products from the removal of water from the fluid reagent. Such side products may be, for example, hydrogen chloride, hydrogen bromide, and the like. In the latter instance, the second porous medium may be coated with a scavenger material that removes the side product. If the side product is hydrogen chloride, for example, the scavenger material may be an aprotic base such as, for example, 3-(dimethylamino)propyl derivatized support, 3-)1,3,4,6,7,8-hexahydro-2H-pyrimido-[1, 2-a]pyrimidino)propyl-derivatized support, 3-(1-morpholino)propyl derivatized support, 3-(1-piperazino)propyl-derivatized support, 3-(piperidino)propyl-derivatized support, 3-(4,4′-trimethylenedipiperidino)propyl-derivatized support, and the like, an electrophilic scavenger such as, for example, 4-ethyl benzenesulfonyl chloride-derivatized support, propionyl chloride-derivatized support, etc., and the like. For desiccants such as, for example, 3-(2-succinic anhydride)propyl derivatized support, no scavenger is necessary because no side products are generally produced.

The scavenger material coating the porous medium should be attached in a substantially irreversible manner so that that material does not become detached during the passage of the fluid reagent through the porous medium. Preferably, the coating material is covalently attached to the porous medium. The coating of the porous medium with the scavenger material may be carried out by known procedures such as, for example, esterification, electrophilic reactions, and the like. In some instances, suitable coated materials are commercially available. The amount of the scavenger material coating the porous medium is dependent on the nature of the fluid reagent, the nature of the side product resulting from the action of the coating material of the first porous medium on the fluid reagent, the nature of the surface of the porous medium, and so forth. In general, the amount of material coating the porous medium is sufficient to achieve the desired level of removal of the side product from the fluid reagent and is usually determined empirically.

The second porous medium may be employed with the first porous medium in a number of ways. In one approach the second porous medium may be admixed with the first porous medium. This approach is particularly applicable where the porous medium is in the form of beads, particles, and the like. Alternatively, the second porous medium may be disposed below the first porous medium, surrounding the first porous medium, surrounded by the first porous medium, and so forth. The primary consideration in this regard is that the fluid reagent contacts the second porous medium after contacting the first porous medium.

It is also within the purview of the present invention to employ a porous medium in conjunction with the fluid reagent passing therethrough as a source of vacuum to provide negative backpressure. The use of a pulse-jet head typically requires that a negative backpressure (that is, a pressure behind the jet), in the range of one to six inches of water, be supplied to the head so that the nozzles form repeatable droplets (27.68 inches of water equals one psi). Several different techniques have been used to provide this negative backpressure. For the most part, these techniques require additional components.

Suitable negative backpressure may be realized in one embodiment of the present invention particularly for a porous medium that has curvature to its outer surface such as, for example, where the porous medium is comprised of beads, particles that pack together to give a porous surface and so forth. The back pressure is generated by the curvature at the fluid interface. In this approach the level of the fluid reagent in the porous medium is controlled by a suitable controller and valve systems so that fluid reagent is below the upper perimeter of the porous medium. In other words the controller and valve system controls the volume of fluid reagents in the fluid channels so that the fluid reagent occupies less than all of the volume of the porous medium. A suitable negative backpressure for any particular apparatus can be readily determined empirically, simply by adjusting the valve system using the controller until the required result is observed.

In this way the porous medium acts as a series of small, high-curvature, thus high pressure jump, sources resulting in the required negative backpressure. The fluid reagent occupies no more than about 99%, no more than about 98%, no more than about 97%, no more than about 96%, no more than about 95%, of the volume created by the porous medium in the channel. The lower limit on the level of fluid reagent is dependent on the amount of fluid reagent sufficient to allow the pulse jet heads to operate effectively and the like. The extent of the negative backpressure may be controlled by the curvature of the porous medium, the level of the fluid reagent in the porous medium, the surface tension of the fluid reagent, and so forth. The relationship may be expressed by the following equation:

ΔP=2Hγ(cosθ_{c})

where ΔP is the pressure jump, H is the mean curvature, γ is the surface tension coefficient and θ_{c} is the contact angle.

The curvature created by the interface on the porous medium is related to the pore size of the porous medium and the contact angle of the fluid reagent with the solid porous medium. The negative backpressure may be increased by decreasing the size of the pores in the medium and/or increasing the surface tension of the liquid. It should be noted that in this embodiment of the present invention, the porous medium may be flexible or non-flexible.

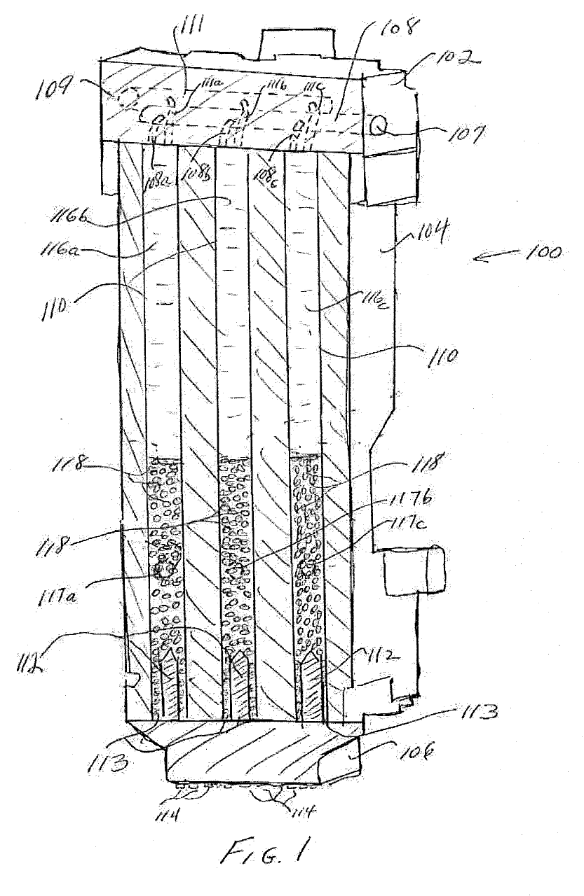

One embodiment of an apparatus in accordance with the present invention is depicted in FIG. 1. Apparatus 100 comprises manifold 102, housing 104 and droplet dispensing device 106. Manifold 102 acts as a cap for the apparatus and provides a seal to the outside and permits introduction of purging gas such as an inert gas through gas port 107, which is in fluid communication with a source of gas (not shown). Gas port 107 provides an entry opening for gas chamber 108, which is formed in manifold 102. Gas chamber 108 is in fluid communication with channels 110 respectively through conduits 108a, 108b and 108c. Manifold 102 also comprises vacuum port 109, which is in fluid communication with a vacuum source (not shown). Vacuum port 109 provides an entry opening for vacuum chamber 111, which is formed in manifold 102. Vacuum chamber 111 is in fluid communication with channels 110 respectively through conduits 111a, 111b and 111c. Droplet dispensing device 106 comprises a plurality of fluid inlets 112, which are disposed in an end portion of channels 110. Droplet dispensing device 106 comprises a plurality of nozzles 114, which are in fluid communication with a respective channel 110. Fluid reagents 116a, 116b and 116c fill channels 110, being introduced through fluid reagent inlets 117a, 117b and 117b, which are respectively connected to sources of fluid reagents (not shown) and which are each disposed in the rear of channels 110. Glass beads 118 are disposed in channels 110 adjacent fluid inlets 112. Each of channels 110 comprises an end portion (113) adapted for engagement with fluid reagent inlet (112). It should be noted that in this embodiment where the fluid reagents fill the channels to an extent that is at least above the glass beads, a suitable vacuum must be applied to achieve the necessary backpressure for the pulse-jet heads. The level of vacuum is generally determined by what the pulse-jet heads require and will support.

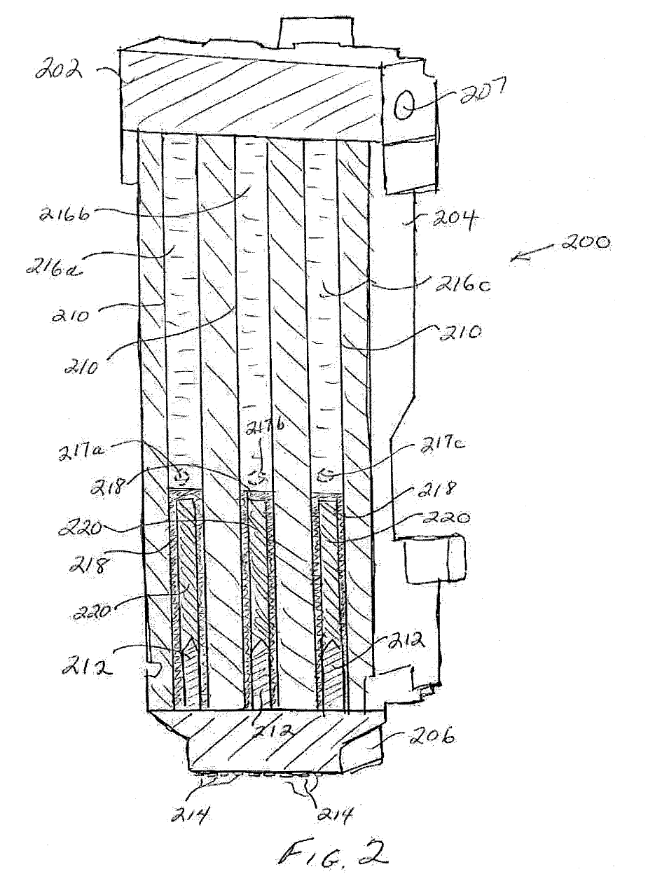

Another embodiment of an apparatus in accordance with the present invention is depicted in FIG. 2. Apparatus 200 comprises manifold 202, housing 204 and droplet dispensing device 206. Manifold 202 comprises a gas port, gas chamber, gas conduits, vacuum port, vacuum chamber and vacuum conduits similar to those shown in FIG. 1 For purposes of clarity, only gas port 207 is shown in FIG. 2. The gas chamber and vacuum chamber are in fluid communication with channels 210 in housing 204. Droplet dispensing device 206 comprises a plurality of fluid inlets 212, which are disposed in an end portion of channels 210. Droplet dispensing device 206 comprises a plurality of nozzles 214, which are in fluid communication with a respective channel 210. Fluid reagents 216a, 216b and 216c fill channels 210, being introduced through fluid reagent inlets 217a, 217b and 217c, which are respectively connected to sources of fluid reagents (not shown) and which are each disposed in the rear of channels 210. Sintered stainless steel inserts 218 are disposed in channels 210 adjacent fluid inlets 212. Inserts 218 are disposed around solid metal cylinders 220.

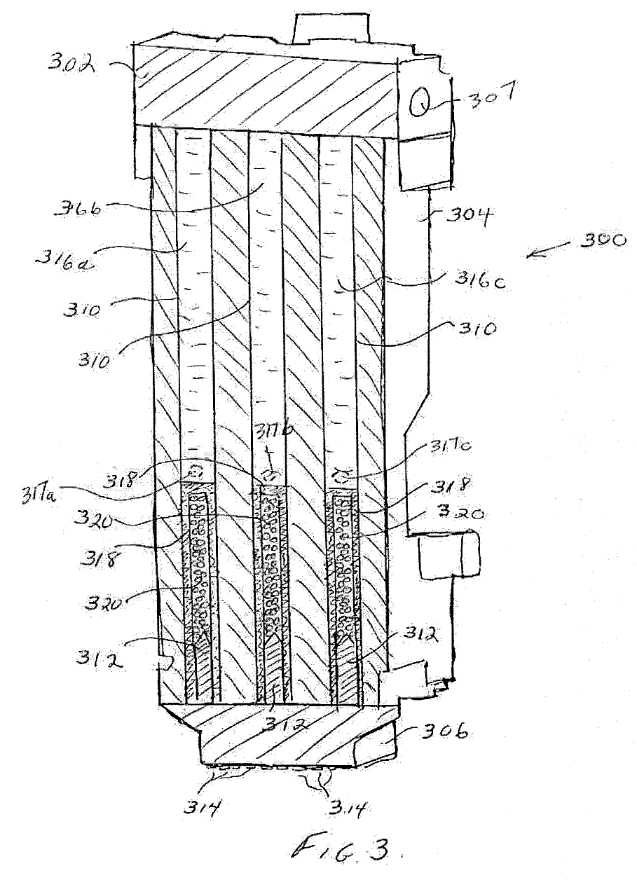

Another embodiment of an apparatus in accordance with the present invention is depicted in FIG. 3. Apparatus 300 comprises manifold 302, housing 304 and droplet dispensing device 306. Manifold 302 comprises a gas port, gas chamber, gas conduits, vacuum port, vacuum chamber and vacuum conduits similar to those shown in FIG. 1 For purposes of clarity, only gas port 307 is shown in FIG. 3. The gas chamber and vacuum chamber are in fluid communication with channels 310 in housing 304. Droplet dispensing device 306 comprises a plurality of fluid inlets 312, which are disposed in an end portion of channels 310. Droplet dispensing device 306 comprises a plurality of nozzles 314, which are in fluid communication with a respective channel 310. Fluid reagents 316a, 316b and 316c fill channels 310, being introduced through fluid reagent inlets 317a, 317b and 317c, which are respectively connected to sources of fluid reagents (not shown) and which are each disposed in the rear of channels 310. Sintered stainless steel inserts 318 are disposed in channels 310 adjacent fluid inlets 312. Inserts 318 are coated with a desiccant. Second porous medium 320 in the form of glass beads coated with a scavenger material. Inserts 318 are disposed around glass beads 320.

Another embodiment of an apparatus in accordance with the present invention is depicted in FIG. 4. Apparatus 160 comprises manifold 162, housing 164 and droplet dispensing device 166. Manifold 162 comprises a gas port, gas chamber, gas conduits, vacuum port, vacuum chamber and vacuum conduits similar to those shown in FIG. 1 For purposes of clarity, only gas port 167 is shown in FIG. 4. The gas chamber and vacuum chamber are in fluid communication with channels 170 in housing 164. Droplet dispensing device 166 comprises a plurality of fluid inlets 172, which are disposed in an end portion of channels 170. Droplet dispensing device 166 comprises a plurality of nozzles 174, which are in fluid communication with a respective channel 170. Glass beads 178 are disposed in channels 170 adjacent fluid inlets 172. Fluid reagents 176a, 176b and 176c fill channels 170 to a point 180 just below the upper perimeter 182 of glass beads 178, being introduced through fluid reagent inlets 177a, 177b and 177c, which are respectively connected to sources of fluid reagents (not shown) and which are each disposed in the rear of channels 170. The necessary negative backpressure is created as discussed in more detail hereinabove. The level of the fluid reagent in the porous medium is controlled by a suitable controller 183 and valve systems 185 (only one shown in FIG. 4) so that fluid reagent is below the upper perimeter of the porous medium. In other words the controller and valve system controls the volume of fluid reagents in the fluid channels so that the fluid reagent occupies less than all of the volume of the porous medium.

Another embodiment of the present invention is an apparatus for synthesizing a plurality of biopolymer features on the surface of a substrate or support. The apparatus comprises a reaction chamber, a droplet dispensing device for dispensing reagents for synthesizing biopolymers on a surface of the substrate, an apparatus as described above in fluid communication with the droplet dispensing device, and a mechanism for moving the droplet dispensing device and the substrate relative to one another. Preferably, the elements of the above apparatus are under computer control.

The components of the synthesis apparatus are normally mounted on a suitable frame in a manner consistent with the present invention. The frame of the apparatus is generally constructed from a suitable material that gives structural strength to the apparatus so that various moving parts may be employed in conjunction with the apparatus. Such materials include, for example, metal, plastic, glass, lightweight composites, and the like.

The synthesis apparatus may also comprise a loading station for loading reagents into the manifold of the present droplet dispensing device. The apparatus further may comprise a mechanism for inspecting the reagent deposited on the surface of the substrate.

The substrate may be mounted on a substrate mount, which may be any convenient structure on which the substrate may be placed and held for depositing reagents on the surface on the substrate. The substrate mount may be of any size and shape and generally has a shape similar to that of the substrate, usually, as large as or slightly larger than the substrate, i.e., about 1 to about 10% larger than the substrate. For example, the substrate mount is rectangular for a rectangular substrate, circular for a circular substrate and so forth. The substrate mount may be constructed from any material of sufficient strength to physically receive and hold the substrate during the deposition of reagents on the substrate surface as well as to withstand the rigors of movement in one or more directions. Such materials include metal, plastic, composites, and the like. The support or substrate may be retained on the substrate mount by gravity, friction, vacuum, and the like.

The fluid dispensing device may be any device that dispenses fluids such as water, aqueous media, organic solvents and the like as droplets of liquid. The fluid dispensing device may comprises a pump for moving fluid and may also comprise a valve assembly with the manifold as well as a means for delivering predetermined quantities of fluid to the surface of a substrate. The fluids may be dispensed by any of the known techniques such as those mentioned above. Any standard pumping technique for pumping fluids may be employed in the dispensing device. For example, pumping may be by means of a peristaltic pump, a pressurized fluid bed, a positive displacement pump, e.g., a syringe pump, and the like.

In one specific embodiment a droplet dispensing device comprises one or more heads. Each head carries hundreds of ejectors or nozzles to deposit droplets. In the case of heads, each ejector may be in the form of an electrical resistor operating as a heating element under control of a processor (although piezoelectric elements could be used instead). Each orifice with its associated ejector and a reservoir chamber, acts as a corresponding pulse-jet with the orifice acting as a nozzle. In this manner, application of a single electric pulse to an ejector causes a droplet to be dispensed from a corresponding orifice (or larger droplets could be deposited by using multiple pulses to deposit a series of smaller droplets at a given location).

As is well known in the art, the amount of fluid that is expelled in a single activation event of a pulse jet, can be controlled by changing one or more of a number of parameters, including the orifice diameter, the orifice length (thickness of the orifice member at the orifice), the size of the deposition chamber, and the size of the heating element, among others. The amount of fluid that is expelled during a single activation event is generally in the range about 0.1 to 1000 pL, usually about 0.5 to 500 pL and more usually about 1.0 to 250 pL. A typical velocity at which the fluid is expelled from the chamber is more than about 1 m/s, usually more than about 10 m/s, and may be as great as about 20 m/s or greater. As will be appreciated, if the orifice is in motion with respect to the receiving surface at the time an ejector is activated, the actual site of deposition of the material will not be the location that is at the moment of activation in a line-of-sight relation to the orifice, but will be a location that is predictable for the given distances and velocities.

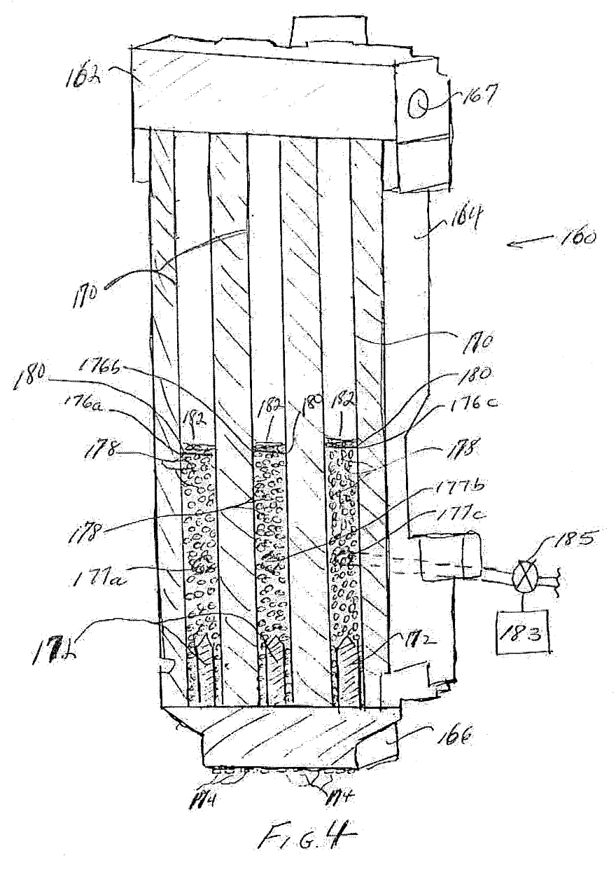

One embodiment of an apparatus in accordance with the present invention is depicted in FIG. 5 in schematic form. Apparatus 400 comprises platform 401 on which the components of the apparatus are mounted. Apparatus 400 comprises main computer 402, with which various components of the apparatus are in communication. Video display 403 is in communication with computer 402. Apparatus 400 further comprises reaction chamber 404, which is controlled by main computer 402. The nature of reaction chamber 404 depends on the nature of the deposition technique employed to add monomers to a growing polymer chain. Such deposition techniques include, by way of illustration and not limitation, pulse-jet deposition, and so forth. Usually, reaction chamber 404 comprises a droplet dispensing apparatus 407 as shown, for example, in FIG. 1. Mechanism 405 is controlled by main computer 402 and moves a droplet dispensing device 407 in reaction chamber 404 into position for depositing fluid reagents on a substrate. Transfer robot 406 is also controlled by main computer 402 and comprises a robot arm 408 that moves a substrate to and from reaction chamber 404. The substrate may be moved to one or more flow cells such as first flow cell 410 or second flow cell 412 for carrying out various procedures for synthesizing the biopolymers such as, for example, oxidation steps, blocking or deblocking steps and so forth. First flow cell 410 is in communication with program logic controller 414, which is controlled by main computer 402, and second flow cell 412 is in communication with program logic controller 416, which is also controlled by main computer 402. First flow cell 410 is in communication with flow sensor and level indicator 418, which is controlled by main computer 402, and second flow cell 412 is in communication with flow sensor and level indicator 420, which is also controlled by main computer 402. First flow cell 410 is in fluid communication with manifolds 422, 424 and 426, each of which is controlled by main computer 402 and each of which is in fluid communication with a source of fluid reagents, namely, 434, 436 and 438, respectively. Second flow cell 412 is in fluid communication with manifolds 428, 430 and 432, each of which is controlled by main computer 402 and each of which is in fluid communication with a source of fluid reagents, namely, 440, 442 and 444, respectively.

As mentioned above, the apparatus and the methods in accordance with the present invention may be automated. To this end the apparatus of the invention further comprises appropriate motors and electrical and mechanical architecture and electrical connections, wiring and devices such as timers, clocks, computers and so forth for operating the various elements of the apparatus. Such architecture is familiar to those skilled in the art and will not be discussed in more detail herein.

To assist in the automation of the present process, the functions and methods may be carried out under computer control, that is, with the aid of a computer. For example, an IBM® compatible personal computer (PC) may be utilized. The computer is driven by software specific to the methods described herein. A preferred computer hardware capable of assisting in the operation of the methods in accordance with the present invention involves a system with at least the following specifications: Pentium® processor or better with a clock speed of at least 100 MHz, at least 32 megabytes of random access memory (RAM) and at least 80 megabytes of virtual memory, running under either the Windows 95 or Windows NT 4.0 operating system (or successor thereof).

Software that may be used to carry out the methods may be, for example, Microsoft Excel or Microsoft Access, suitably extended via user-written functions and templates, and linked when necessary to stand-alone programs that perform other functions. Examples of software or computer programs used in assisting in conducting the present methods may be written, preferably, in Visual BASIC, FORTRAN and C⁺⁺. It should be understood that the above computer information and the software used herein are by way of example and not limitation. The present methods may be adapted to other computers and software. Other languages that may be used include, for example, PASCAL, PERL or assembly language.

As indicated above, the present apparatus and methods may be employed in the preparation of substrates having a plurality of chemical compounds in the form of an array on the surface of such substrates. The chemical compounds may be deposited on the surface of the substrate as fully formed moieties. On the other hand, the chemical compounds may be synthesized in situ in a series of steps such as, for example, the addition of building blocks, which are chemical components of the chemical compound. Examples of such building blocks are those found in the synthesis of polymers. The invention has particular application to chemical compounds that are biopolymers such as polynucleotides, for example, oligonucleotides.

Preferred materials for the substrate itself are those that provide physical support for the chemical compounds that are deposited on the surface or synthesized on the surface in situ from subunits. The materials should be of such a composition that they endure the conditions of a deposition process and/or an in situ synthesis and of any subsequent treatment or handling or processing that may be encountered in the use of the particular array.

Typically, the substrate material is transparent. By “transparent” is meant that the substrate material permits signal from features on the surface of the substrate to pass therethrough without substantial attenuation and also permits any interrogating radiation to pass therethrough without substantial attenuation. By “without substantial attenuation” may include, for example, without a loss of more than 40% or more preferably without a loss of more than 30%, 20% or 10%, of signal. The interrogating radiation and signal may for example be visible, ultraviolet or infrared light. In certain embodiments, such as for example where production of binding pair arrays for use in research and related applications is desired, the materials from which the substrate may be fabricated should ideally exhibit a low level of non-specific binding during hybridization events.

The materials may be naturally occurring or synthetic or modified naturally occurring. Suitable rigid substrates may include glass, which term is used to include silica, and include, for example, glass such as glass available as Bioglass, and suitable plastics. Should a front array location be used, additional rigid, non-transparent materials may be considered, such as silicon, mirrored surfaces, laminates, ceramics, opaque plastics, such as, for example, polymers such as, e.g., poly (vinyl chloride), polyacrylamide, polyacrylate, polyethylene, polypropylene, poly(4-methylbutene), polystyrene, polymethacrylate, poly(ethylene terephthalate), nylon, poly(vinyl butyrate), etc., either used by themselves or in conjunction with other materials. The surface of the substrate is usually the outer portion of a substrate.

The surface of the material onto which the chemical compounds are deposited or formed may be smooth or substantially planar, or have irregularities, such as depressions or elevations. The surface may be modified with one or more different layers of compounds that serve to modify the properties of the surface in a desirable manner. Such modification layers, when present, will generally range in thickness from a monomolecular thickness to about 1 mm, usually from a monomolecular thickness to about 0.1 mm and more usually from a monomolecular thickness to about 0.001 mm. Modification layers of interest include: inorganic and organic layers such as metals, metal oxides, polymers, small organic molecules and the like. Polymeric layers of interest include layers of: peptides, proteins, polynucleic acids or mimetics thereof (for example, peptide nucleic acids and the like); polysaccharides, phospholipids, polyurethanes, polyesters, polycarbonates, polyureas, polyamides, polyethylene amines, polyarylene sulfides, polysiloxanes, polyimides, polyacetates, and the like, where the polymers may be hetero- or homo-polymeric, and may or may not have separate functional moieties attached thereto (for example, conjugated). Various further modifications to the particular embodiments described above are, of course, possible. Accordingly, the present invention is not limited to the particular embodiments described in detail above.

The material used for an array support or substrate may take any of a variety of configurations ranging from simple to complex. Usually, the material is relatively planar such as, for example, a slide. In many embodiments, the material is shaped generally as a rectangular solid. As mentioned above, multiple arrays of chemical compounds may be synthesized on a sheet, which is then diced, i.e., cut by breaking along score lines, into single array substrates.

Typically, the substrate has a length in the range about 5 mm to 100 cm, usually about 10 mm to 25 cm, more usually about 10 mm to 15 cm, and a width in the range about 4 mm to 25 cm, usually about 4 mm to 10 cm and more usually about 5 mm to 5 cm. The substrate may have a thickness of less than 1 cm, or even less than 5 mm, 2 mm, 1 mm, or in some embodiments even less than 0.5 mm or 0.2 mm. The thickness of the substrate is about 0.01 mm to 5.0 mm, usually from about 0.1 mm to 2 mm and more usually from about 0.2 to 1 mm. The substrate is usually cut into individual test pieces, which may be the size of a standard size microscope slide, usually about 3 inches in length and 1 inch in width.

The invention has particular application to substrates bearing oligomers or polymers. The oligomer or polymer is a chemical entity that contains a plurality of monomers. It is generally accepted that the term “oligomers” is used to refer to a species of polymers. The terms “oligomer” and “polymer” may be used interchangeably herein. Polymers usually comprise at least two monomers. Oligomers generally comprise about 6 to about 20,000 monomers, preferably, about 10 to about 10,000, more preferably about 15 to about 4,000 monomers. Examples of polymers include polydeoxyribonucleotides, polyribonucleotides, other polynucleotides that are C-glycosides of a purine or pyrimidine base, or other modified polynucleotides, polypeptides, polysaccharides, and other chemical entities that contain repeating units of like chemical structure. Exemplary of oligomers are oligonucleotides and peptides.

A monomer is a chemical entity that can be covalently linked to one or more other such entities to form an oligomer or polymer. Examples of monomers include nucleotides, amino acids, saccharides, peptoids, and the like and subunits comprising nucleotides, amino acids, saccharides, peptoids and the like. The subunits may comprise all of the same component such as, for example, all of the same nucleotide or amino acid, or the subunit may comprise different components such as, for example, different nucleotides or different amino acids. The subunits may comprise about 2 to about 2000, or about 5 to about 200, monomer units. In general, the monomers have first and second sites (e.g., C-termini and N-termini, or 5′ and 3′ sites) suitable for binding of other like monomers by means of standard chemical reactions (e.g., condensation, nucleophilic displacement of a leaving group, or the like), and a diverse element that distinguishes a particular monomer from a different monomer of the same type (e.g., an amino acid side chain, a nucleotide base, etc.). The initial substrate-bound, or support-bound, monomer is generally used as a building block in a multi-step synthesis procedure to form a complete ligand, such as in the synthesis of oligonucleotides, oligopeptides, oligosaccharides, etc. and the like.

A biomonomer references a single unit, which can be linked with the same or other biomonomers to form a biopolymer (for example, a single amino acid or nucleotide with two linking groups one or both of which may have removable protecting groups). A biomonomer fluid or biopolymer fluid reference a liquid containing either a biomonomer or biopolymer, respectively (typically in solution).

A biopolymer is a polymer of one or more types of repeating units. Biopolymers are typically found in biological systems and particularly include polysaccharides (such as carbohydrates), and peptides (which term is used to include polypeptides, and proteins whether or not attached to a polysaccharide) and polynucleotides as well as their analogs such as those compounds composed of or containing amino acid analogs or non-amino acid groups, or nucleotide analogs or non-nucleotide groups. This includes polynucleotides in which the conventional backbone has been replaced with a non-naturally occurring or synthetic backbone, and nucleic acids (or synthetic or naturally occurring analogs) in which one or more of the conventional bases has been replaced with a group (natural or synthetic) capable of participating in Watson-Crick type hydrogen bonding interactions.

Polynucleotides are compounds or compositions that are polymeric nucleotides or nucleic acid polymers. The polynucleotide may be a natural compound or a synthetic compound. Polynucleotides include oligonucleotides and are comprised of natural nucleotides such as ribonucleotides and deoxyribonucleotides and their derivatives although unnatural nucleotide mimetics such as 2′-modified nucleosides, peptide nucleic acids and oligomeric nucleoside phosphonates are also used. The polynucleotide can have from about 2 to 5,000,000 or more nucleotides. Usually, the oligonucleotides are at least about 2 nucleotides, usually, about 5 to about 100 nucleotides, more usually, about 10 to about 50 nucleotides, and may be about 15 to about 30 nucleotides, in length. Polynucleotides include single or multiple stranded configurations, where one or more of the strands may or may not be completely aligned with another.

A nucleotide refers to a sub-unit of a nucleic acid and has a phosphate group, a 5 carbon sugar and a nitrogen containing base, as well as functional analogs (whether synthetic or naturally occurring) of such sub-units which in the polymer form (as a polynucleotide) can hybridize with naturally occurring polynucleotides in a sequence specific manner analogous to that of two naturally occurring polynucleotides. For example, a “polynucleotide” includes DNA (including cDNA), RNA, oligonucleotides, and PNA and other polynucleotides as described in U.S. Pat. No. 5,948,902 and references cited therein (all of which are incorporated herein by reference), regardless of the source. An “oligonucleotide” generally refers to a nucleotide multimer of about 10 to 100 nucleotides in length, while a “polynucleotide” includes a nucleotide multimer having any number of nucleotides.

The nature of the support or substrate to which a plurality of chemical compounds is attached is discussed above. The substrate can be hydrophilic or capable of being rendered hydrophilic or it may be hydrophobic. The substrate is usually glass such as flat glass whose surface has been chemically activated for binding thereto or synthesis thereon, glass available as Bioglass and the like. The surface of a substrate is normally treated to create a primed or functionalized surface, that is, a surface that is able to support the attachment of a fully formed chemical compound or the synthetic steps involved in the production of the chemical compound on the surface of the substrate. Functionalization relates to modification of the surface of a substrate to provide a plurality of functional groups on the substrate surface. By the term “functionalized surface” is meant a substrate surface that has been modified so that a plurality of functional groups are present thereon usually at discrete sites on the surface. The manner of treatment is dependent on the nature of the chemical compound to be synthesized and on the nature of the substrate surface. In one approach a reactive hydrophilic site or reactive hydrophilic group is introduced onto the surface of the substrate. Such hydrophilic moieties can be used as the starting point in a synthetic organic process.

In one embodiment, the surface of the substrate, such as a glass substrate, is siliceous, i.e., the surface comprises silicon oxide groups, either present in the natural state, e.g., glass, silica, silicon with an oxide layer, etc., or introduced by techniques well known in the art. One technique for introducing siloxyl groups onto the surface involves reactive hydrophilic moieties on the surface. These moieties are typically epoxide groups, carboxyl groups, thiol groups, and/or substituted or unsubstituted amino groups as well as a functionality that may be used to introduce such a group such as, for example, an olefin that may be converted to a hydroxyl group by means well known in the art. One approach is disclosed in U.S. Pat. No. 5,474,796 (Brennan), the relevant portions of which are incorporated herein by reference. A siliceous surface may be used to form silyl linkages, i.e., linkages that involve silicon atoms. Usually, the silyl linkage involves a silicon-oxygen bond, a silicon-halogen bond, a silicon-nitrogen bond, or a silicon-carbon bond.

Another method for attachment is described in U.S. Pat. No. 6,219,674 (Fulcrand, et al.). A surface is employed that comprises a linking group consisting of a first portion comprising a hydrocarbon chain, optionally substituted, and a second portion comprising an alkylene oxide or an alkylene imine wherein the alkylene is optionally substituted. One end of the first portion is attached to the surface and one end of the second portion is attached to the other end of the first portion chain by means of an amine or an oxy functionality. The second portion terminates in an amine or a hydroxy functionality. The surface is reacted with the substance to be immobilized under conditions for attachment of the substance to the surface by means of the linking group.

Another method for attachment is described in U.S. Pat. No. 6,258,454 (Lefkowitz, et al.). A solid substrate having hydrophilic moieties on its surface is treated with a derivatizing composition containing a mixture of silanes. A first silane provides the desired reduction in surface energy, while the second silane enables functionalization with molecular moieties of interest, such as small molecules, initial monomers to be used in the solid phase synthesis of oligomers, or intact oligomers. Molecular moieties of interest may be attached through cleavable sites.

A procedure for the derivatization of a metal oxide surface uses an aminoalkyl silane derivative, e.g., trialkoxy 3-aminopropylsilane such as aminopropyltriethoxy silane (APS), 4-aminobutyltrimethoxysilane, 4-aminobutyltriethoxysilane, 2-aminoethyltriethoxysilane, and the like. APS reacts readily with the oxide and/or siloxyl groups on metal and silicon surfaces. APS provides primary amine groups that may be used to carry out the present methods. Such a derivatization procedure is described in EP 0 173 356 B1, the relevant portions of which are incorporated herein by reference. Other methods for treating the surface of a substrate will be suggested to those skilled in the art in view of the teaching herein.

The devices and methods of the present invention are particularly useful for the preparation of substrates with array areas with array assemblies of biopolymers. Determining the nucleotide sequences and expression levels of nucleic acids (DNA and RNA) is critical to understanding the function and control of genes and their relationship, for example, to disease discovery and disease management. Analysis of genetic information plays a crucial role in biological experimentation. This has become especially true with regard to studies directed at understanding the fundamental genetic and environmental factors associated with disease and the effects of potential therapeutic agents on the cell. Such a determination permits the early detection of infectious organisms such as bacteria, viruses, etc.; genetic diseases such as sickle cell anemnia; and various cancers. This paradigm shift has lead to an increasing need within the life science industries for more sensitive, more accurate and higher-throughput technologies for performing analysis on genetic material obtained from a variety of biological sources.

Unique or misexpressed nucleotide sequences in a polynucleotide can be detected by hybridization with a nucleotide multimer, or oligonucleotide, probe. Hybridization is based on complementary base pairing. When complementary single stranded nucleic acids are incubated together, the complementary base sequences pair to form double stranded hybrid molecules. These techniques rely upon the inherent ability of nucleic acids to form duplexes via hydrogen bonding according to Watson-Crick base-pairing rules. The ability of single stranded deoxyribonucleic acid (ssDNA) or ribonucleic acid (RNA) to form a hydrogen bonded structure with a complementary nucleic acid sequence has been employed as an analytical tool in molecular biology research. An oligonucleotide probe employed in the detection is selected with a nucleotide sequence complementary, usually exactly complementary, to the nucleotide sequence in the target nucleic acid. Following hybridization of the probe with the target nucleic acid, any oligonucleotide probe/nucleic acid hybrids that have formed are typically separated from unhybridized probe. The amount of oligonucleotide probe in either of the two separated media is then tested to provide a qualitative or quantitative measurement of the amount of target nucleic acid originally present.

Direct detection of labeled target nucleic acid hybridized to surface-bound polynucleotide probes is particularly advantageous if the surface contains a mosaic of different probes that are individually localized to discrete, and often known, areas of the surface. Such ordered arrays containing a large number of oligonucleotide probes have been developed as tools for high throughput analyses of genotype and gene expression. Oligonucleotides synthesized on a solid substrate recognize uniquely complementary nucleic acids by hybridization, and arrays can be designed to define specific target sequences, analyze gene expression patterns or identify specific allelic variations. The arrays may be used for conducting cell study, diagnosing disease, identifying gene expression, monitoring drug response, determination of viral load, identifying genetic polymorphisms, analyzing gene expression patterns or identifying specific allelic variations, and the like.

In one approach, cell matter is lysed, to release its DNA as fragments, which are then separated out by electrophoresis or other means, and then tagged with a fluorescent or other label. The resulting DNA mix is exposed to an array of oligonucleotide probes, whereupon selective binding to matching probe sites takes place. The array is then washed and interrogated to determine the extent of hybridization reactions. In one approach the array is imaged so as to reveal for analysis and interpretation the sites where binding has occurred. Arrays of different chemical compounds or moieties or probe species provide methods of highly parallel detection, and hence improved speed and efficiency, in assays. Assuming that the different sequence polynucleotides were correctly deposited in accordance with the predetermined configuration, then the observed binding is indicative of the presence and/or concentration of one or more polynucleotide components of the sample.

An array includes any one-, two- or three- dimensional arrangement of addressable regions bearing a particular biopolymer such as polynucleotides, associated with that region. An array is addressable in that it has multiple regions of different moieties, for example, different polynucleotide sequences, such that a region or feature or spot of the array at a particular predetermined location or address on the array can detect a particular target molecule or class of target molecules although a feature may incidentally detect non-target molecules of that feature.

An array assembly on the surface of a substrate refers to one or more arrays disposed along a surface of an individual substrate and separated by inter-array areas. Normally, the surface of the substrate opposite the surface with the arrays (opposing surface) does not carry any arrays. The arrays can be designed for testing against any type of sample, whether a trial sample, a reference sample, a combination of the foregoing, or a known mixture of components such as polynucleotides, proteins, polysaccharides and the like (in which case the arrays may be composed of features carrying unknown sequences to be evaluated). The surface of the substrate may carry at least one, two, four, or at least ten, arrays. Depending upon intended use, any or all of the arrays may be the same or different from one another and each may contain multiple spots or features of chemical compounds such as, e.g., biopolymers in the form of polynucleotides or other biopolymer. A typical array may contain more than ten, more than one hundred, more than one thousand or ten thousand features, or even more than one hundred thousand features, in an area of less than 20 cm² or even less than 10 cm². For example, features may have widths (that is, diameter, for a round spot) in the range from a 10 μm to 1.0 cm. In other embodiments each feature may have a width in the range of 1.0 μm to 1.0 mm, usually 5.0 μm to 500 μm, and more usually 10 μm to 200 μm. Non-round features may have area ranges equivalent to that of circular features with the foregoing width (diameter) ranges.

Any of a variety of geometries of arrays on a substrate may be used. As mentioned above, an individual substrate may contain a single array or multiple arrays. Features of the array may be arranged in rectilinear rows and columns. This is particularly attractive for single arrays on a substrate. When multiple arrays are present, such arrays can be arranged, for example, in a sequence of curvilinear rows across the substrate surface (for instance, a sequence of concentric circles or semi-circles of spots), and the like. Similarly, the pattern of features may be varied from the rectilinear rows and columns of spots to include, for example, a sequence of curvilinear rows across the substrate surface (for example, a sequence of concentric circles or semi-circles of spots), and the like. The configuration of the arrays and their features may be selected according to manufacturing, handling, and use considerations.

Each feature, or element, within the molecular array is defined to be a small, regularly shaped region of the surface of the substrate. The features are arranged in a predetermined manner. Each feature of an array usually carries a predetermined chemical compound or mixtures thereof. Each feature within the molecular array may contain a different molecular species, and the molecular species within a given feature may differ from the molecular species within the remaining features of the molecular array. Some or all of the features may be of different compositions. Each array may contain multiple spots or features and each array may be separated by spaces or areas. It will also be appreciated that there need not be any space separating arrays from one another. Interarray areas and interfeature areas are usually present but are not essential. As with the border areas discussed above, these interarray and interfeature areas do not carry any chemical compound such as polynucleotide (or other biopolymer of a type of which the features are composed). Interarray areas and interfeature areas typically will be present where arrays are formed by the conventional in situ process or by deposition of previously obtained moieties, as described above, by depositing for each feature at least one droplet of reagent such as from a pulse jet but may not be present when, for example, photolithographic array fabrication processes are used. It will be appreciated though, that the interarray areas and interfeature areas, when present, could be of various sizes and configurations.

The devices and methods of the present invention are particularly useful in the preparation of individual substrates with oligonucleotide arrays for determinations of polynucleotides. In one approach, multiple identical arrays across a complete front surface of a single substrate or support are used.

As mentioned above, biopolymer arrays can be fabricated by depositing previously obtained biopolymers (such as from synthesis or natural sources) onto a substrate, or by in situ synthesis methods. The in situ synthesis methods include those described in U.S. Pat. No. 5,449,754 for synthesizing peptide arrays, as well as WO 98/41531 and the references cited therein for synthesizing polynucleotides (specifically, DNA). Such in situ synthesis methods can be basically regarded as repeating at each spot the sequence of: (a) deprotecting any previously deposited monomer so that it can now link with a subsequently deposited protected monomer; and (b) depositing a droplet of another protected monomer for linking. Different monomers may be deposited at different regions on the substrate during any one iteration so that the different regions of the completed array will have different desired biopolymer sequences. One or more intermediate further steps may be required in each iteration, such as oxidation, capping and washing steps. The deposition methods basically involve depositing biopolymers at predetermined locations on a substrate, which are suitably activated such that the biopolymers can link thereto. Biopolymers of different sequence may be deposited at different regions of the substrate to yield the completed array. Washing or other additional steps may also be used. Reagents used in typical in situ synthesis are water sensitive, and thus the presence of moisture should be eliminated or at least minimized.

The in situ method for fabricating a polynucleotide array typically follows, at each of the multiple different addresses at which features are to be formed, the same conventional iterative sequence used in forming polynucleotides from nucleoside reagents on a substrate by means of known chemistry. This iterative sequence is as follows: (a) coupling a selected nucleoside through a phosphite linkage to a functionalized substrate in the first iteration, or a nucleoside bound to the substrate (i.e. the nucleoside-modified substrate) in subsequent iterations; (b) optionally, but preferably, blocking unreacted hydroxyl groups on the substrate bound nucleoside; (c) oxidizing the phosphite linkage of step (a) to form a phosphate linkage; and (d) removing the protecting group (“deprotection”) from the now substrate bound nucleoside coupled in step (a), to generate a reactive site for the next cycle of these steps. The functionalized substrate (in the first cycle) or deprotected coupled nucleoside (in subsequent cycles) provides a substrate bound moiety with a linking group for forming the phosphite linkage with a next nucleoside to be coupled in step (a). A number of reagents involved in the above synthetic steps such as, for example, phosphoramidite reagents, are sensitive to moisture and anhydrous conditions and solvents are employed. Final deprotection of nucleoside bases can be accomplished using alkaline conditions such as ammonium hydroxide, in a known manner.

The foregoing chemistry of the synthesis of polynucleotides is described in detail, for example, in Caruthers, Science 230: 281-285, 1985; Itakura, et al., Ann. Rev. Biochem. 53: 323-356; Hunkapillar, et al., Nature 310: 105-110, 1984; and in “Synthesis of Oligonucleotide Derivatives in Design and Targeted Reaction of Oligonucleotide Derivatives”, CRC Press, Boca Raton, Fla., pages 100 et seq., U.S. Pat. Nos. 4,458,066, 4,500,707, 5,153,319, and 5,869,643, EP 0294196, and elsewhere.

As mentioned above, various ways may be employed to produce an array of polynucleotides on the surface of a substrate such as a glass substrate. Such methods are known in the art. One in situ method employs pulse-jet technology to dispense the appropriate phosphoramidite reagents and other reagents onto individual sites on a surface of a substrate. Oligonucleotides are synthesized on a surface of a substrate in situ using phosphoramidite chemistry. Solutions containing nucleotide monomers and other reagents as necessary such as an activator, e.g., tetrazole, are applied to the surface of a substrate by means of thermal pulse-jet technology. Individual droplets of reagents are applied to reactive areas on the surface using, for example, a thermal pulse-jet type nozzle. The surface of the substrate may have an alkyl bromide trichlorosilane coating to which is attached polyethylene glycol to provide terminal hydroxyl groups. These hydroxyl groups provide for linking to a terminal primary amine group on a monomeric reagent. Excess of non-reacted chemical on the surface is washed away in a subsequent step. For example, see U.S. Pat. No. 5,700,637 and PCT WO 95/25116 and PCT application WO 89/10977.

Another approach for fabricating an array of biopolymers on a substrate using a biopolymer or biomonomer fluid and using a fluid dispensing head is described in U.S. Pat. No. 6,242,266 (Schleifer, et al.). The head has at least one jet that can dispense droplets onto a surface of a substrate. The jet includes a chamber with an orifice and an ejector, which, when activated, causes a droplet to be ejected from the orifice. Multiple droplets of the biopolymer or biomonomer fluid are dispensed from the head orifice so as to form an array of droplets on the surface of the substrate.

In another embodiment (U.S. Pat. No. 6,232,072) (Fisher) a method of, and apparatus for, fabricating a biopolymer array is disclosed. Droplets of fluid carrying the biopolymer or biomonomer are deposited onto a front side of a transparent substrate. Light is directed through the substrate from the front side, back through a substrate backside and a first set of deposited droplets on the first side to an image sensor.

An example of another method for chemical array fabrication is described in U.S. Pat. No. 6,180,351 (Cattell). The method includes receiving from a remote station information on a layout of the array and an associated first identifier. A local identifier is generated corresponding to the first identifier and associated array. The local identifier is shorter in length than the corresponding first identifier. The addressable array is fabricated on the substrate in accordance with the received layout information.

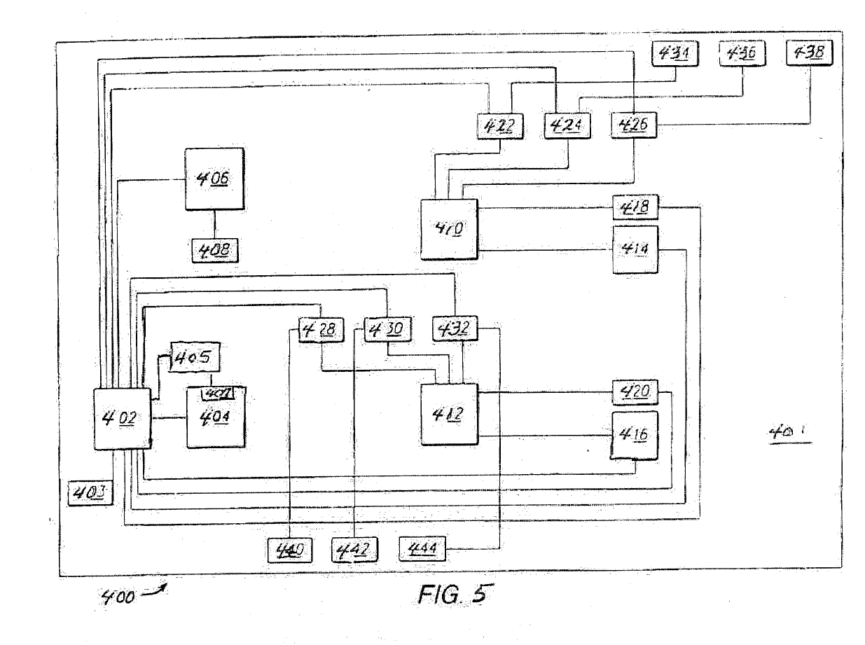

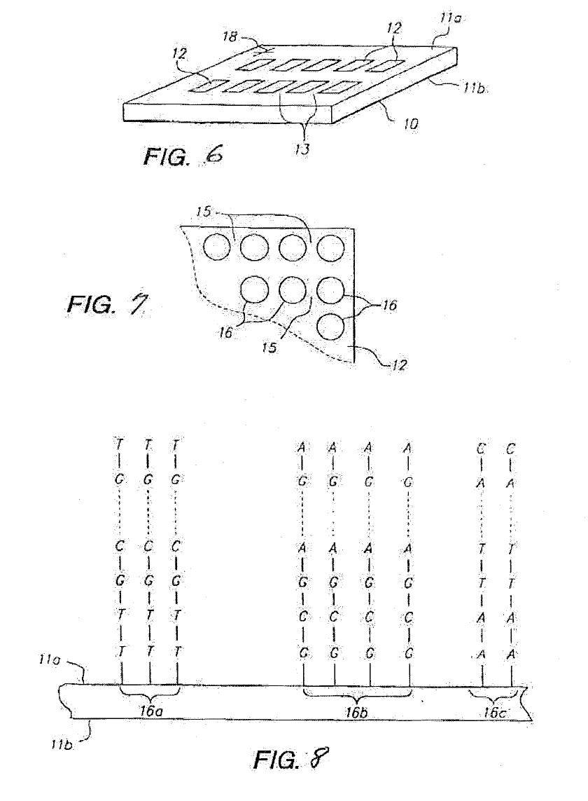

Referring to FIGS. 6-8, there is shown multiple identical arrays 12 (only some of which are shown in FIG. 6), separated by inter-array regions 13, across the complete front surface 11a of a single transparent substrate 10. However, the arrays 12 on a given substrate need not be identical and some or all could be different. Each array 12 will contain multiple spots or features 16 separated by inter-feature regions 15. A typical array 12 may contain from 100 to 100,000 features. At least some, or all, of the features are of different compositions (for example, when any repeats of each feature composition are excluded the remaining features may account for at least 5%, 10%, or 20% of the total number of features). Each feature carries a predetermined moiety (such as a particular polynucleotide sequence), or a predetermined mixture of moieties (such as a mixture of particular polynucleotides). This is illustrated schematically in FIG. 8 where different regions 16 are shown as carrying different polynucleotide sequences.

Substrates comprising polynucleotide arrays may be provided in a number of different formats. In one format, the array is provided as part of a package in which the array itself is disposed on a first side of a glass or other transparent substrate. This substrate is fixed (such as by adhesive) to a housing with the array facing the interior of a chamber formed between the substrate and housing. An inlet and outlet may be provided to introduce and remove sample and wash liquids to and from the chamber during use of the array. The entire package may then be inserted into a laser scanner, and the sample-exposed array may be read through a second side of the substrate.

In another format, the array is present on an unmounted glass or other transparent slide substrate. This array is then exposed to a sample optionally using a temporary housing to form a chamber with the array substrate. The substrate may then be placed in a laser scanner to read the exposed array.

In another format the substrate is mounted on a substrate holder and retained thereon in a mounted position without the array contacting the holder. The holder is then inserted into an array reader and the array read. In one aspect of the above approach, the moieties may be on at least a portion of a rear surface of a transparent substrate, which is opposite a first portion on the front surface. In this format the substrate, when in the mounted position, has the exposed array facing a backer member of the holder without the array contacting the holder. The backer member is preferably has a very low in intrinsic fluorescence or is located far enough from the array to render any such fluorescence insignificant. Optionally, the array may be read through the front side of the substrate. The reading, for example, may include directing a light beam through the substrate from the front side and onto the array on the rear side. A resulting signal is detected from the array, which has passed from the rear side through the substrate and out the substrate front side. The holder may further include front and rear clamp sets, which can be moved apart to receive the substrate between the sets. In this case, the substrate is retained in the mounted position by the clamp sets being urged (such as resiliently, for example by one or more springs) against portions of the front and rear surfaces, respectively. The clamp sets may, for example, be urged against the substrate front and rear surfaces of a mounted substrate at positions adjacent a periphery of that slide. Alternatively, the array may be read on the front side when the substrate is positioned in the holder with the array facing forward (that is, away from the holder).

Regardless of the specific format, the above substrates may be employed in various assays involving biopolymers. For example, following receipt by a user of an array made by an apparatus or method of the present invention, it will typically be exposed to a sample (for example, a fluorescent-labeled polynucleotide or protein containing sample) and the array is then read.

An oligonucleotide probe may be, or may be capable of being, labeled with a reporter group, which generates a signal, or may be, or may be capable of becoming, bound to a support. Detection of signal depends upon the nature of the label or reporter group. Commonly, binding of an oligonucleotide probe to a target polynucleotide sequence is detected by means of a label incorporated into the target. Alternatively, the target polynucleotide sequence may be unlabeled and a second oligonucleotide probe may be labeled. Binding can be detected by separating the bound second oligonucleotide probe or target polynucleotide from the free second oligonucleotide probe or target polynucleotide and detecting the label. In one approach, a sandwich is formed comprised of one oligonucleotide probe, which may be labeled, the target polynucleotide and an oligonucleotide probe that is or can become bound to a surface of a support. Alternatively, binding can be detected by a change in the signal-producing properties of the label upon binding, such as a change in the emission efficiency of a fluorescent or chemiluminescent label. This permits detection to be carried out without a separation step. Finally, binding can be detected by labeling the target polynucleotide, allowing the target polynucleotide to hybridize to a surface-bound oligonucleotide probe, washing away the unbound target polynucleotide and detecting the labeled target polynucleotide that remains. Direct detection of labeled target polynucleotide hybridized to surface-bound oligonucleotide probes is particularly advantageous in the use of ordered arrays.

In one approach, cell matter is lysed, to release its DNA as fragments, which are then separated out by electrophoresis or other means, and then tagged with a fluorescent or other label. The DNA mix is exposed to an array of oligonucleotide probes, whereupon selective attachment to matching probe sites takes place. The array is then washed and the result of exposure to the array is determined. In this particular example, the array is imaged by scanning the surface of the support so as to reveal for analysis and interpretation the sites where attachment occurred.

The signal referred to above may arise from any moiety that may be incorporated into a molecule such as an oligonucleotide probe for the purpose of detection. Often, a label is employed, which may be a member of a signal producing system. The label is capable of being detected directly or indirectly. In general, any reporter molecule that is detectable can be a label. Labels include, for example, (i) reporter molecules that can be detected directly by virtue of generating a signal, (ii) specific binding pair members that may be detected indirectly by subsequent binding to a cognate that contains a reporter molecule, (iii) mass tags detectable by mass spectrometry, (iv) oligonucleotide primers that can provide a template for amplification or ligation and (v) a specific polynucleotide sequence or recognition sequence that can act as a ligand such as for a repressor protein, wherein in the latter two instances the oligonucleotide primer or repressor protein will have, or be capable of having, a reporter molecule and so forth. The reporter molecule can be a catalyst, such as an enzyme, a polynucleotide coding for a catalyst, promoter, dye, fluorescent molecule, chemiluminescent molecule, coenzyme, enzyme substrate, radioactive group, a small organic molecule, amplifiable polynucleotide sequence, a particle such as latex or carbon particle, metal sol, crystallite, liposome, cell, etc., which may or may not be further labeled with a dye, catalyst or other detectable group, a mass tag that alters the weight of the molecule to which it is conjugated for mass spectrometry purposes, and the like.

The signal may be produced by a signal producing system, which is a system that generates a signal that relates to the presence or amount of a target polynucleotide in a medium. The signal producing system may have one or more components, at least one component being the label. The signal producing system includes all of the reagents required to produce a measurable signal. The signal producing system provides a signal detectable by external means, by use of electromagnetic radiation, desirably by visual examination. Signal-producing systems that may be employed in the present invention are those described more fully in U.S. Pat. No. 5,508,178, the relevant disclosure of which is incorporated herein by reference.

The arrays and the liquid samples are maintained in contact for a period of time sufficient for the desired chemical reaction to occur. The conditions for a reaction, such as, for example, period of time of contact, temperature, pH, salt concentration and so forth, are dependent on the nature of the chemical reaction, the nature of the chemical reactants including the liquid samples, and the like. The conditions for binding of members of specific binding pairs are generally well known and will not be discussed in detail here. The conditions for the various processing steps are also known in the art.

The substrates comprising the arrays prepared as described above are particularly suitable for conducting hybridization reactions. Such reactions are carried out on a substrate or support comprising a plurality of features relating to the hybridization reactions. The substrate is exposed to liquid samples and to other reagents for carrying out the hybridization reactions. The support surface exposed to the sample is incubated under conditions suitable for hybridization reactions to occur.

After the appropriate period of time of contact between the liquid samples and the arrays on the surface of the substrate, the contact is discontinued and various processing steps are performed. Following the processing of the substrate, it is moved to an examining device where the surface of the substrate on which the arrays are disposed is interrogated. The examining device may be a scanning device involving an optical system.

Reading of the array may be accomplished by illuminating the array and reading the location and intensity of resulting fluorescence at each feature of the array. For example, a scanner may be used for this purpose where the scanner may be similar to, for example, the AGILENT MICROARRAY SCANNER available from Agilent Technologies Inc, Palo Alto, Calif. Other suitable apparatus and methods are described in U.S. patent applications: Ser. No. 09/846,125 “Reading Multi-Featured Arrays” by Dorsel, et al.; and U.S. Pat. No. 6,406,849. The relevant portions of these references are incorporated herein by reference. However, arrays may be read by methods or apparatus other than the foregoing, with other reading methods including other optical techniques (for example, detecting chemiluminescent or electroluminescent labels) or electrical techniques (where each feature is provided with an electrode to detect hybridization at that feature in a manner disclosed in U.S. Pat. Nos. 6,221,583 and 6,251,685, and elsewhere). Results from the reading may be raw results (such as fluorescence intensity readings for each feature in one or more color channels) or may be processed results such as obtained by rejecting a reading for a feature that is below a predetermined threshold and/or forming conclusions based on the pattern read from the array (such as whether or not a particular target sequence may have been present in the sample). The results of the reading (processed or not) may be forwarded (such as by communication) to a remote location if desired, and received there for further use (such as further processing).

When one item is indicated as being “remote” from another, this is referenced that the two items are at least in different buildings, and may be at least one mile, ten miles, or at least one hundred miles apart. “Communicating” information references transmitting the data representing that information as electrical signals over a suitable communication channel (for example, a private or public network). “Forwarding” an item refers to any means of getting that item from one location to the next, whether by physically transporting that item or otherwise (where that is possible) and includes, at least in the case of data, physically transporting a medium carrying the data or communicating the data.

All publications and patent applications cited in this specification are herein individually incorporated by reference.

Although the foregoing invention has been described in some detail by way of illustration and example for purposes of clarity of understanding, it will be readily apparent to those of ordinary skill in the art in light of the teachings of this invention that certain changes and modifications may be made thereto without departing from the spirit or scope of the appended claims. Furthermore, the foregoing description, for purposes of explanation, used specific nomenclature to provide a thorough understanding of the invention. However, it will be apparent to one skilled in the art that the specific details are not required in order to practice the invention. Thus, the foregoing descriptions of specific embodiments of the present invention are presented for purposes of illustration and description; they are not intended to be exhaustive or to limit the invention to the precise forms disclosed. Many modifications and variations are possible in view of the above teachings. The embodiments were chosen and described in order to explain the principles of the invention and its practical applications and to thereby enable others skilled in the art to utilize the invention.

What is claimed is:

1. A method for reducing or eliminating deleterious effects caused by pressure transients on the droplet dispensing action of a droplet dispensing device used in the fabrication of an array of chemical compounds on a surface of a substrate, said dispensing device comprising a plurality of nozzles, said method comprising passing one or more fluid reagents for the fabrication of said array through a non-flexible porous medium and into said droplet dispensing device.

2. A method according to claim 1 wherein said porous medium is integral.

3. A method according to claim 2 wherein said porous medium is selected from the group consisting of sintered metal and expanded metal.

4. A method according to claim 1 wherein said porous medium is non-integral.

5. A method according to claim 4 wherein said porous medium is a particulate material.

6. A method according to claim 1 wherein said porous medium is coated with a desiccant material.

7. A method according to claim 6 wherein said porous medium is selected from the group consisting of 4-ethyl benzenesulfonyl chloride derivatized porous medium, propionyl chloride derivatized porous medium, propionyl bromide derivatized porous medium and 3-(2-succinic anhydride) propyl derivatized porous medium.

8. A method according to claim 6 wherein said porous medium is in combination with a second porous medium, which is coated with a scavenger material.

9. A method according to claim 8 wherein said scavenger material is an aprotic base.

10. A method according to claim 1 wherein said fluid reagent occupies less than all of the volume of said porous medium to provide a negative backpressure for said droplet dispensing device.

11. A method according to claim 1 wherein said porous medium is adjacent an inlet into said droplet dispensing device.

12. An apparatus for introducing a fluid reagent into an inlet of a droplet dispensing device used in the fabrication of an array of chemical compounds on a surface of a substrate, said droplet dispensing device comprising a plurality of nozzles, said apparatus comprising:
(a) a housing,
(b) one or more fluid reagent channels in said housing having an end portion adapted for engagement with an fluid reagent inlet of said droplet dispensing device, and
(c) a non-flexible porous medium in each of said channels adjacent said end portion.

13. An apparatus according to claim 12 wherein said porous medium is selected from the group consisting of particulate material and sintered metal.

14. An apparatus according to claim 12 wherein said porous medium is coated with a desiccant material.

15. An apparatus according to claim 14 wherein said porous medium is selected from the group consisting of 4-ethyl benzenesulfonyl chloride derivatized porous medium, propionyl chloride derivatized porous medium, propionyl bromide derivatized porous medium and 3-(2-succinic anhydride) propyl derivatized porous medium.

16. An apparatus according to claim 14 wherein said porous medium is in combination with a second porous medium, which is coated with a scavenger material.

17. An apparatus according to claim 16 wherein said scavenger material is an aprotic base.

18. An apparatus according to claim 12 further comprising a controller for controlling the volume of fluid reagents in said fluid channels so that said fluid reagent occupies less than all of the volume of said porous medium.

19. An apparatus according to claim 12 further comprising one or more ports for receiving fluids and directing fluids to said channels.

20. An apparatus for synthesizing a plurality of biopolymer features on the surface of a substrate, said apparatus comprising:
(a) a reaction chamber,
(b) a droplet dispensing device for dispensing reagents for synthesizing biopolymers on a surface of said substrate,
(c) an apparatus according to claim 12 in fluid communication with said droplet dispensing device, and
(d) a mechanism for moving said droplet dispensing device and said substrate relative to one another.

21. An apparatus according to claim 20 wherein said dispensing device comprises a plurality of nozzles for dispensing said reagents as droplets to the surface of said substrate.

22. An apparatus according to claim 20, which is under computer control.

23. A method for synthesizing an array of biopolymers on a surface of a substrate, said method comprising, in multiple rounds of subunit additions, adding one or more polymer subunits at each of multiple feature locations on said surface to form one or more arrays on said surface, each round of subunit additions comprising:
(a) bringing said substrate and a dispensing system for dispensing said polymer subunits for the synthesis of said biopolymers into a dispensing position relative to said activated discrete sites on said surface, said dispensing system comprising a droplet dispensing device and an apparatus according to claim 12,
(b) dispensing said polymer subunits to said discrete sites,
(c) removing said substrate and/or said dispensing system from said relative dispensing position, and
(d) repeating steps (a)-(c).

24. A method according to claim 23 wherein said biopolymers are polynucleotides or polypeptides.

25. A method according to claim 24 further comprising exposing the array to a sample and reading the array.

26. A method comprising forwarding data representing a result obtained from a reading of an array exposed according to the method of claim 25.

27. A method according to claim 26 wherein the data is transmitted to a remote location.

28. A method comprising receiving data representing a result of an interrogation obtained by reading of an array exposed according to the method of claim 25.

29. A method according to claim 24 wherein multiple arrays are synthesized on the surface of said substrate and said substrate is diced into individual sections comprising one or more arrays.

30. A method for creating a negative backpressure at the nozzles of a droplet dispensing device comprising a plurality of fluid reagent inlets, said method comprising having in fluid communication with each fluid reagent inlet a volume of a porous medium and controlling the flow of fluid reagents through said porous medium so that said fluid reagent occupies less than all of the volume of said porous medium to provide a negative backpressure for said droplet dispensing device.

31. A method according to claim 30 wherein said porous medium is a bead.
